(19) United States
(12) Patent Application Publication
(10) Pub. No.: US 2026/0187285 A1
(43) Pub. Date: Jul. 2, 2026

(54) SERVER APPARATUS, SYSTEM, AND METHOD FOR ASSET TOKENIZATION AND STORAGE

(71) Applicant: RAMDVG Limited, Dublin (IE)

(72) Inventors: Hussien Sleiman, New Port Beach, CA (US); Richard Howell, Bowral (AU); Andrew Seaton, Hong Kong (HK); Mark Western, London (GB)

(21) Appl. No.: 19/006,293

(22) Filed: Dec. 31, 2024

(51) Int. Cl. G06F 21/64

(52) U.S. Cl. CPC G06F 21/64

(57) ABSTRACT

Aspects concern a computer-implemented method for asset tokenization and storage, comprising: receiving a request for an asset to be tokenized on a distributed ledger; providing asset data of the asset; generating a token representing the asset, wherein the token complies with a predefined token standard, the token comprises a token metadata; generating, using a hash function, a first hash based on the asset data; generating, using the hash function, a second hash based on the token metadata; comparing the second hash with the first hash; and providing a notification indicative of data integrity in a positive determination that there is a match between the second hash and the first hash.

### TECHNICAL FIELD

Various aspects of this disclosure relate to a server apparatus, system, and method for asset tokenization and storage.

### BACKGROUND

The following discussion of the background is intended to facilitate an understanding of the present disclosure only. It should be appreciated that the discussion is not an acknowledgment or admission that any of the material referred to was published, known, or is part of the common general knowledge of the person skilled in the art in any jurisdiction as of the priority date of the disclosure.

Various methods and/or systems have been employed to tokenize assets, but the existing solutions often suffer from limitations such as lack of data consistency and/or difficulty in verification. In particular, current tokenization systems typically do not effectively verify the consistency between data stored in a distributed ledger, such as a blockchain, and external asset information.

In addition, current methods may have inadequate protection against data tampering. In particular, tampered or altered data may go undetected, compromising the integrity of the tokenized assets.

Accordingly, the disclosure seeks to provide a server apparatus, system, and method for processing data, to ameliorate the aforementioned limitations at least in part.

### SUMMARY

The disclosure seeks to provide a system, server apparatus, and method to address the aforementioned limitations by providing a technical solution that utilizes a plurality of checksums to verify data consistency between data stored in a distributed ledger, for example, blockchain (hereinafter referred to as internal data), and data stored in an external database. The data may be associated with different assets, including, but not limited to, aircraft-related data. Such an approach facilitates the maintenance of data integrity, such that even minor changes to the data result in significantly different check-sums.

According to an aspect of the present disclosure, there is provided a computer-implemented method for asset tokenization and storage, the method comprising: receiving a request for an asset to be tokenized on a distributed ledger; providing asset data of the asset; generating a token representing the asset, wherein the token complies with a predefined token standard, the token comprises a token metadata; generating, using a hash function, a first hash based on the asset data; generating, using the hash function, a second hash based on the token metadata; comparing the second hash with the first hash; and providing a notification indicative of data integrity in a positive determination that there is a match between the second hash and the first hash. In some embodiments, the second hash may be generated based on one of the following: a combination of the token metadata and the first hash; or a combination of the token metadata and the asset data.

In some embodiments, the distributed ledger is a blockchain, and optionally a permissioned blockchain.

In some embodiments, the method further comprises storing the asset data of the asset in an off-chain or off-ledger external database.

In some embodiments, the off-chain or off-ledger external database is part of a decentralized storage solution or system, and optionally an interplanetary file system.

In some embodiments, the method further comprises concatenating the asset data with the token metadata.

In some embodiments, the method further comprises providing a notification indicative of data discrepancy in a negative determination that there is a match between the second hash and the first hash.

In some embodiments, generating the first hash based on the asset data comprises generating a first checksum; and generating the second hash based on the token metadata comprises generating a second checksum, and wherein comparing the second hash with the first hash comprises comparing the first checksum and the second checksum. In some embodiments, the second checksum is generated based on the concatenated asset data with the token metadata.

In some embodiments, the blockchain is an Ethereum blockchain, and the predefined token standard is an ERC-20 or ERC-721 standard.

In some embodiments, the asset is an airplane, and the asset data includes one or more of the following: maintenance log data, leasing contracts data, flight logs data, operational data and financial data.

In some embodiments, the first hash and the second hash are cryptographic hashes.

In some embodiments, the method further comprises storing the first hash in the distributed ledger and comparing any subsequently generated second hash with the stored first hash.

According to another aspect of the present disclosure there is provided a system for asset tokenization and storage, comprising: a database configured to store asset data of an asset; a distributed ledger configured to receive, from the database, a request to tokenize the asset; and upon receipt of the request to tokenize the asset; the distributed ledger is configured to generate a token representing the asset, wherein the token complies with a predefined token standard, the token comprises a token metadata; initiate a hash generation process to a smart contract module; wherein the smart contract module, upon receipt of a hash generation process initialization request or command, is configured to: obtain the asset data from the database; generate, using a hash function, a first hash based on the asset data; generate, using the hash function, a second hash based on the token metadata; compare the second hash with the first hash; and provide a notification indicative of data integrity in a positive determination that there is a match between the second hash and the first hash. In some embodiments, the second hash may be generated based on one of the following: a combination of the token metadata and the first hash; or a combination of the token metadata and the asset data.

In some embodiments, the distributed ledger is a blockchain, and optionally a permissioned blockchain.

In some embodiments, the database is an off-chain or off-ledger external database.

In some embodiments, the off-chain or off-ledger external database is part of a decentralized storage solution, and optionally an interplanetary file system.

In some embodiments, the smart contract module is further configured to concatenate the asset data with the token metadata.

In some embodiments, the smart contract module is configured to provide a notification indicative of data discrepancy in a negative determination that there is a match between the second hash and the first hash.

In some embodiments, the generation of the first hash based on the asset data comprises generating of a first checksum; and the generation of the second hash based on the token metadata comprises generating a second checksum, and wherein comparison of the second hash with the first hash comprises comparing the first checksum and the second checksum. In some embodiments, the second checksum is generated based on the concatenated asset data with the token metadata.

In some embodiments, the blockchain is an Ethereum blockchain, and the predefined token standard is an ERC-20 or ERC-721 standard.

In some embodiments, the asset is an airplane, and the asset data includes one or more of the following: maintenance log data, leasing contracts data, flight logs data, operational data and financial data.

According to another aspect of the present disclosure there is provided a non-transitory computer-readable medium or computer program product storing computer executable code comprising instructions for asset tokenization and storage, according to any one of the described methods.

### BRIEF DESCRIPTION OF THE DRAWINGS

The disclosure will be better understood with reference to the detailed description when considered in conjunction with the non-limiting examples and the accompanying drawings, in which:

FIG. 1A is a schematic block diagram of a server apparatus for processing requests for tokenization and storage of asset data.

FIG. 1B is a schematic block diagram comprising the server apparatus of FIG. 1A, and one or more real-world asset system, implemented as a system for asset tokenization, storage, and verification.

FIG. 2 shows a block diagram of a system for asset tokenization and storage.

FIG. 3 is a general flow chart of a method for asset tokenization and storage according to the present disclosure.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments, which are non-limiting examples, described in the context of one of the enclosure systems, server devices, or methods are analogously valid for the other systems, devices, or methods. Similarly, embodiments described in the context of a system are analogously valid for a device or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements. Furthermore, as used in the present disclosure and the appended claims, the term “by” may also mean “from”, depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

As used herein, the term “data” may be understood to include information in any suitable analogue or digital form, for example, provided as a file, a portion of a file, a set of files, a signal or stream, a portion of a signal or stream, a set of signals or streams, waveforms, and the like. The term data, however, is not limited to the aforementioned examples and may take various forms and represent any information as understood in the art. In some embodiments, the term asset data may refer to information about any asset, such as, but not limited to, aircraft, aircraft engine, property, art piece, commodity or financial instrument. Key details might include asset provenance, asset status, asset maintenance history, current valuation, valuation history, ownership details, location (for real estate), asset ID, and any other unique identifiers. The asset data may be associated with other applications such as real-estate, supply-chain management, etc.

As used herein, the term “module” refers to, forms part of, or includes an application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A single module or a combination of modules may be regarded as a device. A processor may include one or more modules. For example, multiple modules described in this disclosure may form a processor.

As used herein, the term “associate”, “associated”, and “associating” indicate a defined relationship (or cross-reference) between two items.

As used herein, the term “obtain”, in the context of obtaining data, broadly include pull technology used any time a transfer of data is initiated by a request sent from a client to a server. Push technology, on the other hand, is implemented any time a transfer of information is initiated by a server without waiting on a request from a client. In some embodiments, the term obtain may include receive.

As used herein, “memory” may be understood as a non-transitory computer-readable medium in which data or information can be stored. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

As used herein, the term “configured to” broadly refers to an arrangement, a design, and/or a program to perform a specific function. It implies a purposeful arrangement or adaptation for achieving the stated functionality. For example, a processor configured to process data may include hardware (e.g. electronic circuitry, chips), and/or software working in tandem to process the data.

As used herein, a “distributed ledger” broadly refers to one or more databases that are decentralized in nature, eliminating the need for an intermediary to process, validate or authenticate transactions. A blockchain is a specific example of a distributed ledger. The blockchain may be a private blockchain or a public blockchain.

As used herein, a “token” in blockchain refers to a digital representation of an asset or utility that is managed and secured on a blockchain. Tokens may be classified broadly into fungible tokens and non-fungible tokens. Fungible tokens may include identical and interchangeable tokens, such as cryptocurrencies (e.g., Bitcoin, Ethereum, or ERC-20 tokens). Non-fungible tokens (NFTs) may include unique tokens with distinct attributes, often representing ownership of digital or physical assets (e.g., ERC-20 or ERC-721 tokens). Tokenization is the process of converting data associated with an asset into a digital token recorded on a distributed ledger, such as a blockchain. A tokenization process may include creating a digital equivalent of a physical, financial, or digital asset, enabling it to be transferred, stored, or managed using blockchain technology. In some embodiments, tokenization may include representation of tangible assets (e.g., aircraft, real estate, commodities) or intangible assets (e.g., intellectual property, carbon credits). In some embodiments, a smart contract may be used to enforce the rules and conditions of the tokenized asset, such as ownership, transferability, and compliance with regulations.

As used herein, a “hash” may be generated by applying a hash function to an input of arbitrary size. The purpose of hashing is to transform input data into a unique digital fingerprint, often referred to as the hash value or digest. Hashes may be used in cryptography, particularly in blockchain systems. In some embodiments, the hash may include a cryptographic output having a defined or fixed length, generated from input data using a hashing/hash function (for example, secure hash algorithm SHA-256). The Secure Hash Algorithm 256 may be used in blockchain systems. For any given input, it produces a 256-bit (32-byte) hash. The hash uniquely represents the input and will change entirely if the input is modified in any way. Hash functions may be understood as one-way functions that provide unique outputs for each unique input.

As used herein, “checksums” are small, derived value used to verify the integrity of data. It is computed by applying a mathematical or algorithmic operation to the data and then comparing it with a checksum value stored or transmitted with the data. If the computed checksum matches the stored checksum, the data is considered valid; otherwise, it indicates corruption or tampering. In some embodiments, a checksum may be appended to data to quickly validate its correctness before applying computationally expensive operations (e.g., generating or verifying a full cryptographic hash). In some embodiments, when generating a hash, a checksum can be incorporated into the process to ensure that the input data has not been altered or corrupted prior to the hashing operation.

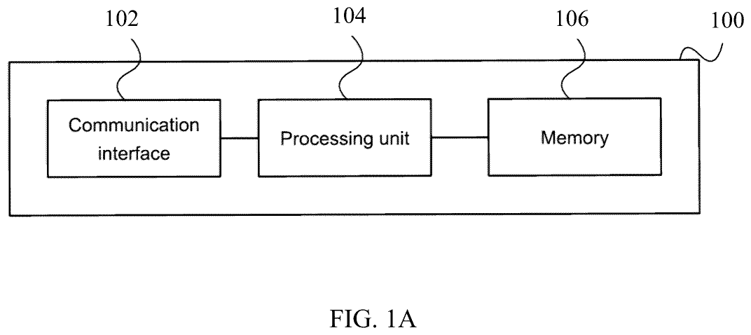

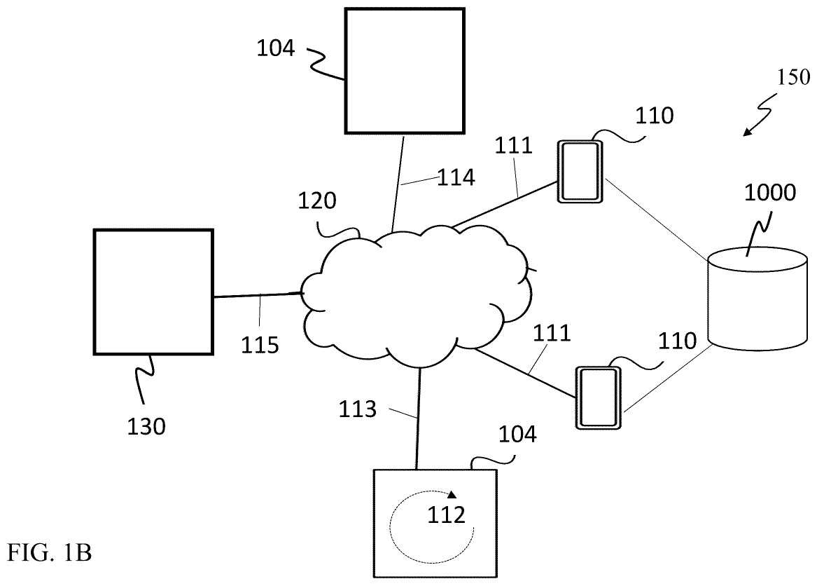

According to an aspect of the disclosure and with reference to FIG. 1, there is provided a server apparatus for processing one or more requests for assets to be tokenized on a distributed ledger. The server apparatus may be part of a distributed system, the server apparatus configured, arranged, and/or operable to receive requests for tokenization and storage of data associated with one or more asset, asset class or asset type. The server apparatus may form a node of a distributed ledger system, or may be arranged in data communication with one or more nodes of a distributed ledger system. In some embodiments, the distributed ledger system may be implemented in a cloud computing network, wherein a blockchain can create a decentralized network of nodes that share data and processing power. The blockchain may be arranged or configured as a distributed network of computers.

The server apparatus may comprise a processor and a memory, the processor is capable of being configured to execute instructions stored in the memory to receive a request for tokenization. In the embodiment illustrated in FIG. 1A and FIG. 1B, the server apparatus may be a communications server apparatus. The communications server apparatus may be in the form of a server computer 100, the server computer 100 may be a single server as illustrated schematically in FIG. 1A, or have the functionality performed distributed across multiple server components.

In some embodiments, the server computer 100 includes a communication interface 102. The communication interface 102 may be configured to send and receive data, which may include requests for asset data tokenization and storage. The communication interface 102 may include a transmitter module and/or a receiver module allowing the server apparatus to communicate over a communications network. The communication interface 102 may include one or more user-interfaces configured to provide users for user control and may include, for example, one or more computing peripheral devices such as display monitors, computer keyboards and the like.

The server computer 100 may further include a processor in the form of processing unit 104 and a memory 106. The memory 106 may be used by the processing unit 104 to store, for example, one or more requests for tokenization and storage of asset data, one or more status data, encrypted data, hash functions for performing verification, verification records, such as checksum records, and notification records for successful and/or non-successful verification.

As shown in FIG. 1B, the processing unit 104 may be configured to receive, from one or more terminal devices 110, a request for tokenization 111 for processing. The request for tokenization 111 may be parsed to obtain information or data relating to one or more asset. The asset may be an airplane or aircraft, an aircraft part, aircraft engine, and/or one or more other parts of the aircraft. The asset data includes one or more of the following: maintenance log data, leasing contracts data, flight logs data, operational data, one or more identifiers of the aircraft, and financial data. It is appreciable that the asset may include tangible or intangible property, art piece, commodity and/or financial instrument. In some embodiments, the asset data may include asset provenance, asset status, asset maintenance history, past and/or current valuation of an asset, valuation history, ownership details, location (for real estate), asset ID, and any other unique identifiers.

The server computer 100 and one or more terminal devices 110 may be connected via a network 120 to form a system 150 for tokenization of the asset data. The network 120 may be an Internet or Intranet network. In some embodiments, the network 120 may be a distributed ledger network, such as a blockchain network. In some embodiments, the distributed ledger network may be implemented in a cloud computing configuration. In some embodiments, the system 150 may comprise one or more notification system or server 130 to send and/or receive notifications or alerts from other modules.

The server computer 100 may be configured to obtain one or more requests for tokenization from the one or more terminal devices 110, the one or more terminal devices 110 may be arranged in data or signal communication with a database 1000, such as a real-world asset system or database. The obtaining of one or more requests for tokenization may be facilitated by using a monitoring algorithm (regarded as software sensors) installed on either the real-world asset system and/or the server computer 100. The processing unit 104 may then be configured to process the one or more requests for tokenization, including initiating a hashing process and generating records in the distributing ledger network. In some embodiments, the one or more requests for tokenization 111 may be sent directly from the database 1000 to the server computer 100, bypassing the terminal devices 110.

In some embodiments, the processing unit 104, upon receipt of the one or more requests for tokenization, may then be operable/configured generate a token 112 representing the asset, wherein the token 112 may comply with a predefined token standard. The token may include token metadata. The processing unit 104 may initiate a hash generation process; wherein the hash generation may include the processing unit 104 configured to: obtain the asset data from the database; generate, using a hash function, a first hash 113 based on the asset data; generate, using the hash function, a second hash 114 based on the token metadata; compare the second hash with the first hash; and provide a notification 115 indicative of data integrity in a positive determination that there is a match between the second hash and the first hash. In some embodiments, the token metadata may include any information stored on the distributed ledger (blockchain) representing the asset, such as a token identifier (ID), one or more ownership records, issuance date, and attributes related to the asset.

In some embodiments, the processing unit 104 may be configured to concatenate the asset data obtained from the database, with the token metadata. The second hash may then be applied to the combination of the asset data and the token metadata. In some embodiments, instead of combining the asset data and the token metadata, the second hash may be generated based on the token metadata and the first hash.

In some embodiments, the processing unit 104 may be configured to store the second hash in the token, which is in turn stored in the server computer 100 functioning as a node of the blockchain. The token 112 may be configured as a cryptographic key to access the data store associated with the asset, data in any format, or a combination of data files in any formats can be used as the asset data repository.

It may be appreciable that the only constraints on the amount of data associated with any asset is determined by the data repository or database chosen, and is not limited by any attributes or limitations inherent to the token.

It is appreciable that the expansion of the quantum of data that can be stored and associated with a token in this manner may be differentiated from the prior art where tokens are ‘daisy chained’ together to grow beyond the size limitation of any single token.

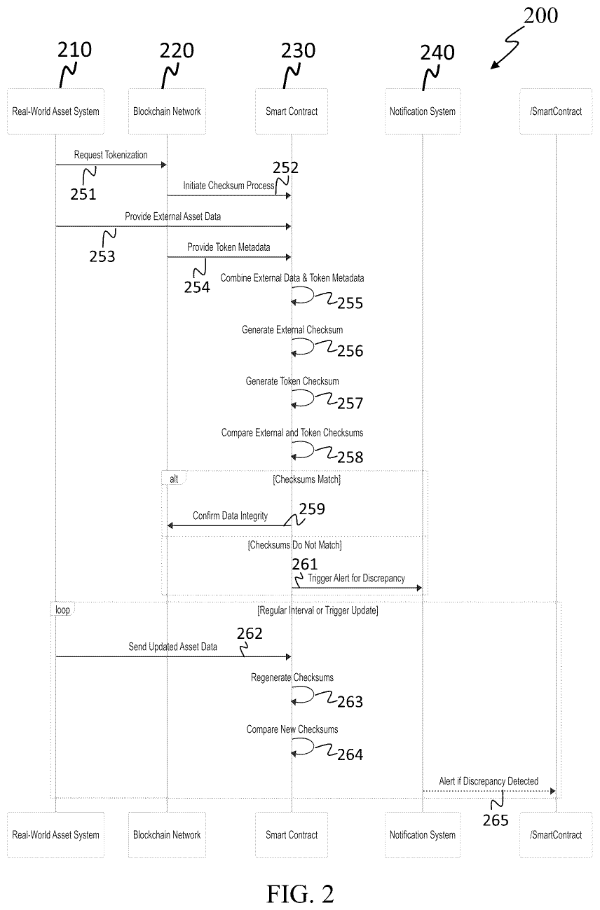

FIG. 2 is a block diagram of a system 200 for asset tokenization and storage. The system 200 comprises a database module 210 configured to store asset data of an asset, a distributed ledger 220 configured to receive, from the database module 210, a request to tokenize the asset; and upon receipt of the request to tokenize the asset; the distributed ledger 220 is configured to generate a token representing the asset, wherein the token complies with a predefined token standard, the token comprises a token metadata; initiate a hash generation process to a smart contract module 230; wherein the smart contract module 230, upon receipt of a hash generation process initialization request or command, is configured to: obtain the asset data from the database; generate, using a hash function, a first hash based on the asset data; generate, using the hash function, a second hash based on the token metadata; compare the second hash with the first hash; and provide a notification indicative of data integrity in a positive determination that there is a match between the second hash and the first hash.

The system 200 may include a notification module 240, the notification module 240 configured to receive the notification from the smart contract module 230 and generate one or more notifications to be sent to the smart contract module 230.

In some embodiments, the distributed ledger is a blockchain, and optionally a permissioned blockchain.

In some embodiments, the database is an off-chain or off-ledger external database. The off-chain or off-ledger external database may be part of a decentralized storage solution, and optionally an interplanetary file system (IPFS). The IPFS may be configured as an off-chain storage system to complement the distributed ledger network 220. While distributed ledger technology, such as blockchain, may excel at recording ownership and transactions, it may not be suitable for storing relatively large datasets like airplane maintenance logs or leasing contracts. Therefore, a combination of off-chain storage and blockchain may be utilized for more efficient data management.

In some embodiments, the off-chain or off-ledger external database, such as, but not limited to IPFS, may be configured to store relatively large datasets and dynamic records. These off-chain systems may be configured to handle the data's size and complexity while allowing efficient retrieval and updates.

In some embodiments, large data files for storage with the database module 210 may be fragmented into smaller segments or chunks, encoded, and distributed across nodes in the IPFS network to enhance redundancy and resilience.

In some embodiments, each data segment or chunk may be assigned a unique cryptographic hash identifier, enabling immutable and verifiable referencing within the blockchain.

In some embodiments, the smart contract module 230 is further configured to combine or concatenate the asset data with the token metadata. The smart contract module 230 is configured to provide a notification indicative of data discrepancy in a negative determination that there is a match between the second hash and the first hash.

The generation of the first hash based on the asset data may comprise generating a first checksum; and the generation of the second hash based on the token metadata may comprise generating a second checksum, and wherein comparison of the second hash with the first hash comprises comparing the first checksum and the second checksum.

In some embodiments, the blockchain may be an Ethereum blockchain, and the predefined token standard is an ERC-20 or ERC-721 standard.

FIG. 2 further shows the data flow between the various modules 210, 220, 230, and 240, of the system 200 in the tokenization process, which may include the generation of one or more checksums for verification. The database module 210 may form part of a real-world asset system. The real-world asset system may comprise the necessary input/output interface to send and receive asset data for storage. The asset data may be stored or organized in various formats, such as, but not limited to, JavaScript Object Notation (JSON) format. In general, the database module 210 may support the storage and retrieval of data in any format—structured (e.g., JSON, XML), semi-structured (e.g., CSV, YAML), or unstructured (e.g., videos, images, PDFs). The database module 210 may include interoperable file-handling modules within the data repository to facilitate the storage and retrieval of data in any format.

The process may commence with a request for tokenization 251 sent from the real-world asset system to the distributed ledger 220, which may include a blockchain network. The blockchain network may then send an initialization for hashing, i.e. initialize a checksum process 252 to the smart contract module 230. The smart contract module 230 may be operable to receive the external asset data 203 from the real-world asset system, i.e. the real-world asset system may be configured to send 253 the external asset data to the smart contract module 230. In some embodiments, the external asset data may be sent using a push data configuration to the smart contract module 230. In other embodiments, the smart contract module 230 may be configured to pull data from the real-world asset system upon receipt of the initiate checksum process.

In some embodiments, system 200 may be configured to prepare the data for hashing based on gathering or extracting, from the database 210, data associated with the asset, which may include up-to-date asset information. In some embodiments, the preparation of the data may include collecting token data, such as token metadata. The collected token metadata on the blockchain may represent the most recent record of the asset's characteristics as represented in the digital token.

The token metadata may be provided 254 to the smart contract module 230.

The external asset data and the token metadata may be combined 255 to create a combined data set. The external data and token metadata may be combined in a standard, ordered way using a predefined structure such as a concatenation of asset attributes in a consistent order. The combined data set facilitates the contribution of both data sources to the generation of a hash, making it an accurate reflection of both asset and token states.

A hashing process is carried out by generating checksums. The external data may be hashed using a secure hash function, such as, but not limited to, SHA-256 hash function, to generate an external checksum 256. The combined data from the blockchain token may be hashed to generate an internal checksum 257 (also referred to token checksum).

After the external checksum and the internal checksum are generated, the two checksums may be compared 258.

The tokenization platform or smart contract module 230 may compare the external checksum to the internal checksum stored within the token. In a positive determination that both the checksums match, the data integrity is confirmed 259. If they do not match (i.e. a negative determination), it may indicate that the token data or external asset data has changed. A notification may then be triggered and sent 261 to the notification module 240. The notification may be configured in the form of an alert for discrepancy.

In some embodiments, the real-world asset system may be configured to send, periodically 262 or on-demand, updated asset data to the smart contract module 230 for verification. Upon receipt of the updated asset data for verification, the smart contract module 230 may be configured to run or regenerate the checksum 263 comparisons at regular intervals or upon certain triggers, for example, after a transfer of ownership or update of the asset data. The regenerated checksums may then be compared 264. In some embodiments, in a positive determination that the regenerated checksum comparison fails, the notification module 240 may be configured to send an alert to an issuer or relevant parties to investigate potential discrepancies 265.

To maintain data integrity over time, sensors, including hardware and/or software sensors, may be positioned or configured to detect changes in the asset data within the real-world asset system. Examples of such changes may include property values or rental yields.

In some embodiments, the system 200 may include a mechanism to update the blockchain token's metadata and regenerate the checksums whenever a change in the asst data is detected. The mechanism may be further configured to detect whether such changes are approved changes.

In some embodiments, authorized sign-offs on updates to the token metadata may be required to prevent unauthorized changes to the token's checksum.

In some embodiments, each checksum generation and comparison may be logged and stored as an immutable audit trail on the blockchain module. Such digital log may enable the verification of past checksums to facilitate historical consistency, transparency in records for regulators, auditors, or potential investors, showing that the token data has accurately reflected the asset over time.

In some embodiments, the tokenization process may be elaborated in the context of the example of an aircraft or airplane asset.

The request for tokenization may be in the form of tokenizing a piece of Airplane The token metadata on the blockchain may include and identifier (asset ID), an aircraft model descriptor, a present value of the aircraft, and an ownership information, as follows.
Asset ID: 12345
Model: Boeing_737_800
Current Value: $55,000,000
Owner: John Smith

The corresponding real-world (external) asset data may be stored in an off-chain system managed by the token issuer. This data may be hashed, and the checksum is generated. The same hashing process happens on the blockchain data. These two checksums are compared as follows:
External checksum generated from asset system: 7c4a8d09ca3762af61e59520943dc26494f8941b
Blockchain token checksum: 7c4a8d09ca3762af61e59520943dc26494f8941b
If both checksums match, data integrity is confirmed. If the checksums do not match, data integrity is not confirmed, and further alerts may be sent and/or checks may be carried out.

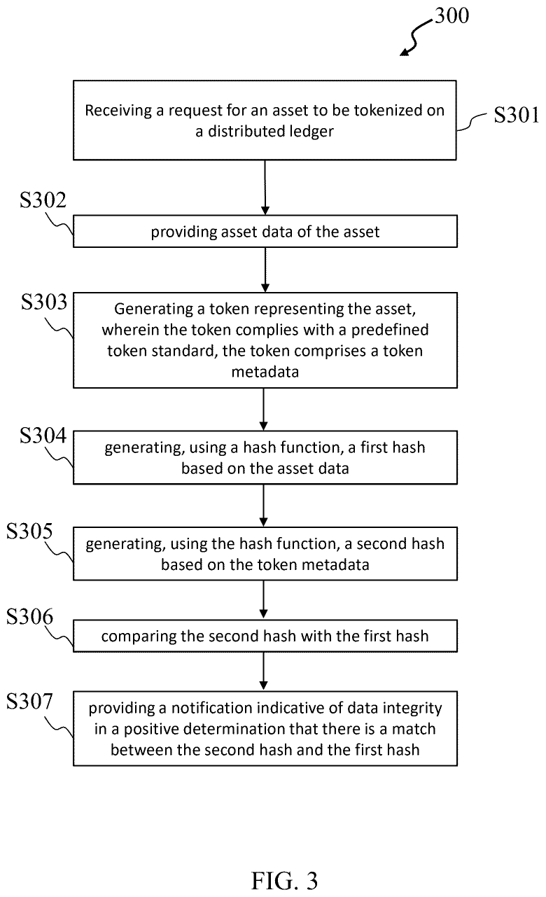

FIG. 3 shows a generalized flow chart of a method 300 for processing one or more requests for tokenization and storage of asset data, according to the present disclosure. The method 300 comprises the steps of:
Step S301: receiving a request for an asset to be tokenized on a distributed ledger;
Step S302: providing asset data of the asset;
Step S303: generating a token representing the asset, wherein the token complies with a predefined token standard, the token comprises a token metadata;
Step S304: generating, using a hash function, a first hash based on the asset data;
Step S305: generating, using the hash function, a second hash based on the token metadata;
Step S306: comparing the second hash with the first hash; and
Step S307: providing a notification indicative of data integrity in a positive determination that there is a match between the second hash and the first hash.

In some embodiments, the external asset data, i.e. off-chain data, may comprise one or more of the following parameters and/or variables expressed in JSON format. It may be understood that the various values, including “null”, are for illustration purpose and may be replace by other values where the data are available.
{
   “name”: “Airbus A321-251MX”,
   “description”: Lease Info,
   “manufacturerDate”: null,
   “manufacturerSerialNumber”: “0156”,
   “url”: null, “registrationCountryCode”: “PHL”,
   “regulatorReason”: null,
   “canTransfer”: null,
   “registrationNumber”: “F-MONY”,
   “aircraftSpecificationsType”: “A321_251NX”,
   “manufacturer”: “Airbus”,
   “model”: “A321-251NX”,
   “rampInspectionCompleteStatus”: null,
   “capetownRegistered”: false,
   “aircraftExteriorDetails”: {
      “exteriorHeight”: null,
      “exteriorWidth”: null,
      “exteriorDepth”: null,
      “externalBaggage”: null,
      “wingSpan”: null,
      “tailHeight”: null
      },
   “aircraftOperatingDetails”: {
      “thrustRating”: 35000,
      “maxTakeOffWeight”: 89000,
      “maxZeroFuelWeigth”: 75600,
      “maxLandingWeight”: 79200,
      “reducedVerticalSeparationMinimum”: null,
      “lowVisibilityOperations”: null,
      “extendedDiversionTimeOperations”: null,
      “approachCapability”: true,
      “steepApproachCapability”: null,
      “requiredNavigationPerformance”: null,
      “basicEmptyWeight”: null,
      “operatingWeight”: null,
      “fuelCapacity”: null,
      “payloadWithFullFuel”: null,
      “maxPayload”: null,
      “maxOperationMachNumber”: null,
      “dateOfLastAircraftWeighting”: null
      }
   “aircraftUtilizationDetails”: {
      “totalTimeSinceNew”: 2119,
      “totalCyclesSinceNew”: 513
   }
}
]

In some embodiments, the token metadata may comprise one or more of the following parameters and/or variables expressed in JSON format. It may be understood that the various values are for illustration purpose and may be replace by other values where the data are available.
{
   “token_id”: “TOKEN12345”,
   “token_standard”: “ERC-721”,
   “asset_id”: “AIR12345”,
   “asset_type”: “aircraft”,
   “created_on”: “2024-12-28T12:00:00Z”,
   “integrity_hash”:
   “dcbf5c5e647c56b1aef2a9f4ef5a978edc8f9b3e5e3f03d4a74b8c3edecb9f5c”,
   “token_status”: “PENDING”
}

Hash of Asset Data: Using a hashing function SHA-256, the JSON string of the asset data is hashed to produce the first hash:
Hash (Asset Data): e3b0c44298fc1c149afbf4c8996fb92427ae41e4649b934ca495991b7852b855
Hash of Token Metadata: Similarly, the token metadata is hashed to produce the second hash:
Hash (Token Metadata): dcbf5c5e647c56b1aef2a9f4ef5a978edc8f9b3e5e3f03d4a74b8c3edecb9f5c

In some embodiments, the hash functions used in step S304 and S305 may be one or more of the following: SHA-256 (Secure Hash Algorithm 256-bit); SHA-3 (Keccak); RIPEMD-160; Blake2; Scrypt; Ethash; Argon2; SHA-512.

In some embodiments, different hash functions may be used to generate the first hash and the second hash respectively. It may be appreciable that the use of different hash/hashing functions to generate hashes for the token metadata and for the asset data, the same being the off-chain data store. It may be appreciable that certain hash functions may work more expeditiously and economically with certain data types. Furthermore, using different hash functions for different data targets may reduce any potential risks of security vulnerabilities arising from using only a single hashing function. In some embodiments, the hash functions to be used may be defined in the smart contract module. The cryptographic key which is used as the basis for each hash generation may be intrinsic to the token itself. That is, the token may be configured to function as the cryptographic key for hash generation and for data verification, regardless of the hash generation functions employed.

In some embodiments, the distributed ledger is a blockchain, and optionally a permissioned blockchain.

In some embodiments, the method further comprises storing the asset data of the asset in an off-chain or off-ledger external database.

In some embodiments, the off-chain or off-ledger external database is part of a decentralized storage solution, and optionally an interplanetary file system.

In some embodiments, the method further comprises concatenating the asset data with the token metadata.

In some embodiments, the method further comprises providing a notification indicative of data discrepancy in a negative determination that there is a match between the second hash and the first hash.

In some embodiments, generating the first hash based on the asset data comprises generating a first checksum; and generating the second hash based on the token metadata comprises generating a second checksum, and wherein comparing the second hash with the first hash comprises comparing the first checksum and the second checksum.

In some embodiments, the asset is an airplane, and the asset data includes one or more of the following: maintenance log data, leasing contracts data, flight logs data, operational data and financial data.

In some embodiments, the first hash and the second hash are cryptographic hashes. The second hash may be stored in the distributed ledger (e.g. blockchain) for the comparison with any subsequently generated first hash with the stored second hash.

In the various embodiments described, the blockchain may be an Ethereum blockchain, and the predefined token standard may be an ERC-20 or ERC-721 token standard. The Ethereum blockchain may be configured to use a linked list of data blocks, each data block containing a header with metadata such as a parent block hash, a timestamp, and a nonce. The Ethereum blockchain may include a list of transactions that encode state changes.

In some embodiments, the asset data may be stored as a known file format in the off-chain database of the real-world asset system 210. The files may be managed by the IPFS file system, which may be configured to incorporate any blockchain.

In some embodiments, the token generated may not be limited to static data. The generated token may incorporate mechanisms to update or extend data linked to the asset through dynamic data linking. For example, a new data file can be added to the database or repository.

In some embodiments, existing data within the database can be version-controlled and linked under the token.

In some embodiments, the method may include token minting, which may include the creation of an initial supply of tokens, representing ownership of the aircraft/engine. These tokens can be fractionalized and then distributed to investors or sold through token offerings.

In some embodiments, the smart contract module 230 is configured to define functions such as token minting, transfer, and revenue distribution, facilitating the seamless management of ownership aspects.

In some embodiments, as alternative or in addition to the IPFS, one or more known external database management system may be configured to store dynamic asset data such as leasing schedules, financial reports, and other frequently updated information. The known external database management system may beMySQL, PostgreSQL. These systems can be synchronized with the blockchain to facilitate real-time accuracy and accessibility.

In some embodiments, the Ethereum blockchain may be configured to supports two types of accounts: externally owned accounts (EOAs), controlled by private keys, and contract accounts, controlled by smart contract code. The Ethereum blockchain supports fungible and non-fungible tokens through standards such as ERC-20 and ERC-721.

This present disclosure provides a technical solution that utilizes a plurality of checksums to verify data consistency between data stored in a distributed ledger, for example, blockchain (hereinafter referred to as internal data), and data stored in an external database. The methods described herein may be performed and the various processing or computation units and the devices and computing entities described herein may be implemented by one or more circuits.

In summary, an asset data, such as, but not limited to aircraft data, may include maintenance logs, leasing contracts, and certification documents, images, etc. may be stored off-chain, in a decentralized storage solution like IPFS or in a secure centralized database. A cryptographic hash (e.g., using SHA-256) may then be generated from the stored asset data. The generated hash is then recorded on the blockchain as a reference point for that specific dataset. Whenever the data is required to be verified or accessed, the off-chain data is retrieved, and a new hash may be generated to compare it against the original hash (which is a combination of token metadata and asset data) stored on the blockchain. If the hashes match, it confirms that the data has not been tampered with and remains authentic. Otherwise, a notification of a discrepancy may be generated. Such an approach provide the scalability and efficiency of off-chain storage for large datasets and the security and immutability of blockchain for tracking data integrity. By combining these two systems, asset data may be safely managed, easily accessible, and fully verifiable while maintaining the integrity and security that blockchain offers.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

Any method disclosed herein may be performed by a processor performing instructions that are stored on a non-transitory computer readable medium. That is, a non-transitory computer readable medium may include instructions which, if executed by a processor, cause the processor to perform any method disclosed herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A non-transitory computer readable medium, comprising instructions which, if executed by a processor, cause the processor to:
receive a request for an asset to be tokenized on a distributed ledger;
provide asset data of the asset;
generate a token representing the asset, wherein the token complies with a predefined token standard, the token comprises a token metadata;
generate, using a hash function, a first hash based on the asset data;
generate, using the hash function, a second hash based on the token metadata;
compare the second hash with the first hash; and
provide a notification indicative of data integrity in a positive determination that there is a match between the second hash and the first hash.

2. The non-transitory computer readable medium of claim 1, wherein the distributed ledger is a blockchain, and optionally a permissioned blockchain.

3. The non-transitory computer readable medium of claim 1, wherein the instructions are further configured to cause the processor to store the asset data of the asset in an off-chain or off-ledger external database.

4. The non-transitory computer readable medium of claim 3, wherein the off-chain or off-ledger external database is part of a decentralized storage solution, and optionally an interplanetary file system.

5. The non-transitory computer readable medium of claim 1, wherein the second hash is generated using one of the following: a combination of the token metadata and the first hash; or a combination of the token metadata and the asset data, and wherein the combination optionally comprises concatenating the asset data or the first hash with the token metadata.

6. The non-transitory computer readable medium of claim 1, wherein the instructions are further configured to cause the processor to provide a notification indicative of data discrepancy in a negative determination that there is a match between the second hash and the first hash.

7. The non-transitory computer readable medium of claim 1, wherein the generating the first hash based on the asset data comprises generating a first checksum; and generating the second hash based on the token metadata comprises generating a second checksum, and wherein comparing the second hash with the first hash comprises comparing the first checksum and the second checksum.

8. The non-transitory computer readable medium of claim 2, wherein the blockchain is an Ethereum blockchain, and the predefined token standard is an ERC-20 or ERC-721 standard.

9. The non-transitory computer readable medium of claim 1, wherein the asset is an airplane, and the asset data includes one or more of the following: maintenance log data, leasing contracts data, flight logs data, operational data and financial data.

10. The non-transitory computer readable medium of claim 1, wherein the first hash and the second hash are cryptographic hashes.

11. The non-transitory computer readable medium of claim 1, wherein the instructions are further configured to cause the processor to store the second hash in the distributed ledger and compare any subsequently generated first hash with the stored second hash.

12. A system for asset tokenization and storage, comprising:
a database configured to store asset data of an asset;
a distributed ledger configured to receive, from the database, a request to tokenize the asset; and upon receipt of the request to tokenize the asset; the distributed ledger is configured to generate a token representing the asset, wherein the token complies with a predefined token standard, the token comprises a token metadata; initiate a hash generation process to a smart contract module;
wherein the smart contract module, upon receipt of a hash generation process initialization request or command, is configured to:
obtain the asset data from the database;
generate, using a hash function, a first hash based on the asset data;
generate, using the hash function, a second hash based on a combination of the token metadata and the asset data;
compare the second hash with the first hash; and
provide a notification indicative of data integrity in a positive determination that there is a match between the second hash and the first hash.

13. The system of claim 12, wherein the distributed ledger is a blockchain, and optionally a permissioned blockchain.

14. The system of claim 12, wherein the database is an off-chain or off-ledger external database.

15. The system of claim 14, wherein the off-chain or off-ledger external database is part of a decentralized storage solution, and optionally an interplanetary file system.

16. The system of claim 12, wherein the smart contract module is further configured to concatenate the asset data with the token metadata.

17. The system of claim 12, wherein the smart contract module is configured to provide a notification indicative of data discrepancy in a negative determination that there is a match between the second hash and the first hash.

18. The system of claim 12, wherein the generation of the first hash based on the asset data comprises generating of a first checksum; and the generation of the second hash based on the token metadata comprises generating a second checksum, and wherein comparison of the second hash with the first hash comprises comparing the first checksum and the second checksum.

19. The system of claim 13, wherein the blockchain is an Ethereum blockchain, and the predefined token standard is an ERC-20 or ERC-721 standard.

20. The system of claim 12, wherein the asset is an airplane, and the asset data includes one or more of the following: maintenance log data, leasing contracts data, flight logs data, operational data and financial data.
